(19) United States
(12) Patent Application Publication
(10) Pub. No.: US 2024/0048279 A1
(43) Pub. Date: Feb. 8, 2024

(54) METHODS, DEVICES, AND COMPUTER READABLE MEDIUM FOR COMMUNICATION

(71) Applicant: NEC CORPORATION, Tokyo (JP)

(72) Inventors: Gang WANG, Beijing (CN); Lin LIANG, Beijing (CN)

(73) Assignee: NEC CORPORATION, Tokyo (JP)

(21) Appl. No.: 18/266,134

(22) PCT Filed: Dec. 10, 2020
(86) PCT No.: PCT/CN2020/135358

§ 371 Date: Jun. 8, 2023

(51) Int. Cl. H04L 1/1812; H04W 72/232; H04W 72/1273; H04L 5/14

(52) U.S. Cl. CPC H04L 1/1812; H04W 72/232; H04W 72/1273; H04L 5/1469

(57) ABSTRACT

According to embodiments of the present disclosure, a solution for supporting repetitions for a plurality of downlink data transmission scheduled by signal downlink control information is proposed. A terminal device receives downlink control information scheduling a plurality of downlink data transmissions with repetitions from a network device. The terminal device determines a HARQ-ACK codebook for the plurality of downlink data transmissions based on a repetition pattern for the plurality of downlink data transmissions and the slot offset. The terminal device transmits a feedback for the repetitions for the downlink data transmissions based on the HARQ-ACK codebook to the network device. In this way, it achieves a flexible repetition patterns for the plurality of downlink data transmissions scheduled by signal DCI, which improves the coverage/reliability performance for data transmission.

### TECHNICAL FIELD

Embodiments of the present disclosure generally relate to the field of telecommunication, and in particular, to methods, devices, and computer readable medium for communication.

### BACKGROUND

In order to improve coverage or reliability performance for data transmission, repetitions for a single downlink data transmission has been proposed. The number of repetitions for the single downlink data transmissions may be semi-static configured. Alternatively, the number of repetitions may be indicated dynamically. Further, a terminal device can transmit a feedback for the downlink data transmission. Moreover, a position for transmitting the feedback is also a key aspect.

### SUMMARY

In general, example embodiments of the present disclosure provide a solution for communication.

In a first aspect, there is provided a method for communication. The communication method comprises: receiving, at a terminal device and from a network device, downlink control information scheduling a plurality of downlink data transmissions with repetitions, the downlink control information indicating a slot offset between the last repetition of the last downlink data transmission in the plurality of downlink data transmissions and a transmission of an uplink control channel; determining, based on the slot offset and a repetition pattern for the plurality of downlink data transmissions, a hybrid automatic repeat request acknowledgment (HARQ-ACK) codebook for the plurality of downlink data transmissions; and transmitting, to the network device and on the uplink control channel, the HARQ-ACK codebook comprising feedbacks for the plurality of downlink data transmissions.

In a second aspect, there is provided a method for communication. The communication method comprises transmitting, at a network device and to a terminal device, downlink control information scheduling a plurality of downlink data transmissions with repetitions, the downlink control information indicating a slot offset between the last repetition of the last downlink data transmission in the plurality of downlink data transmissions and a transmission of an uplink control channel; and receiving, from the terminal device and on the uplink control channel, a hybrid automatic repeat request acknowledgment (HARQ-ACK) codebook comprising feedbacks for the plurality of downlink data transmissions, which is determined based on the slot offset and a repetition pattern for the plurality of downlink data transmissions.

In a third aspect, there is provided a terminal device. The terminal device comprises a processing unit; and a memory coupled to the processing unit and storing instructions thereon, the instructions, when executed by the processing unit, causing the terminal device to perform acts comprising: receiving, at a terminal device and from a network device, downlink control information scheduling a plurality of downlink data transmissions with repetitions, the downlink control information indicating a slot offset between the last repetition of the last downlink data transmission in the plurality of downlink data transmissions and a transmission of an uplink control channel; determining, based on the slot offset and a repetition pattern for the plurality of downlink data transmissions, a hybrid automatic repeat request acknowledgment (HARQ-ACK) codebook for the plurality of downlink data transmissions; and transmitting, to the network device and on the uplink control channel, the HARQ-ACK codebook comprising feedbacks for the plurality of downlink data transmissions.

In a fourth aspect, there is provided a network device. The network device comprises a processing unit; and a memory coupled to the processing unit and storing instructions thereon, the instructions, when executed by the processing unit, causing the network device to perform acts comprising: transmitting, at a network device and to a terminal device, downlink control information scheduling a plurality of downlink data transmissions with repetitions, the downlink control information indicating a slot offset between the last repetition of the last downlink data transmission in the plurality of downlink data transmissions and a transmission of an uplink control channel; and receiving, from the terminal device and on the uplink control channel, a hybrid automatic repeat request acknowledgment (HARQ-ACK) codebook comprising feedbacks for the plurality of downlink data transmissions, which is determined based on the slot offset and a repetition pattern for the plurality of downlink data transmissions.

In a fifth aspect, there is provided a computer readable medium having instructions stored thereon, the instructions, when executed on at least one processor, causing the at least one processor to carry out the method according to any one of the first aspect or second aspect.

Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 is a schematic diagram of a communication environment in which embodiments of the present disclosure can be implemented;

FIG. 2 illustrates a signaling flow for preventing frequent handover and/or cell re-selection according to some embodiments of the present disclosure;

FIGS. 3A and 3B illustrate simplified block diagrams of repetition patterns according to some embodiments of the present disclosure;

FIG. 4 illustrates a simplified block diagram of a repetition pattern according to some embodiments of the present disclosure;

FIG. 5 illustrates a simplified block diagram of a HARQ-ACK codebook according to some embodiments of the present disclosure;

FIGS. 6A and 6B illustrate simplified block diagrams of HARQ-ACK codebooks according to some embodiments of the present disclosure;

FIG. 7 illustrates a simplified block diagram of a HARQ-ACK codebook according to some embodiments of the present disclosure;

FIG. 8 is a flowchart of an example method in accordance with an embodiment of the present disclosure;

FIG. 9 is a flowchart of an example method in accordance with an embodiment of the present disclosure; and

FIG. 10 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a satellite network device, an aircraft network device, and the like. For the purpose of discussion, in the following, some example embodiments will be described with reference to eNB as examples of the network device.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. In the following description, the terms “terminal device”, “communication device”, “terminal”, “user equipment” and “UE” may be used interchangeably.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

Communications discussed herein may use conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the singular forms “a”, “an” and “the” are intended to include the plural forms as well, unless the context clearly indicates otherwise. The term “includes” and its variants are to be read as open terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As mentioned above, the repetitions for the single downlink data transmission has been proposed. Potential enhancements to physical downlink control channel (PDCCH) monitoring including potential limitation to UE PDCCH configuration, multiple physical downlink shared channel/physical uplink shared channel (PDSCH/PUSCH) scheduling with single downlink control information (DCI) (using conventional DCI formats or new DCI format(s)), spatial relation management for grant configured(GC)-PDCCH, capability related to PDCCH monitoring, and PDCCH coverage should be further investigated for higher subcarrier spacing, including the need for such enhancements. However, whether and how to support the repetitions for a plurality of PDSCH scheduled by single DCI is not discussed and specified now.

According to some conventional technologies, for the case of single DCI scheduling multiple transport blocks with repetitions, scheduling of transport blocks repetitions is down selected between: option 1: all the repetitions for one transport block (TB) are contiguously scheduled in valid UL/DL subframes; and option 2: The repetitions for one transport block are interleaved with repetitions of all the other transport blocks. The above options may be applied for unicast only. For the DL/UL unicast for a UE, when multiple TBs are scheduled by one DCI, the parameter values for {Modulation and Coding Scheme (MCS), Resource assignment, Repetitions} are the same across all the TBs scheduled by that DCI.

Moreover, in other conventional technologies, for unicast multi-TB scheduling, hybrid automatic repeat request (HARQ)-acknowledgement (ACK) multiplexing in control element mode B may be not supported. For UEs that support multi-TB scheduling with HARQ-ACK bundling, the bundling may be enabled/disabled/configured by radio resource control (RRC) and the actual bundle size may be indicated by DCI. Moreover, for multi-TB scheduling with single DCI, if DL unicast with bundled HARQ feedback in half duplex-frequency division duplex (HD-FDD), the starting (absolute) subframe S_{B}_{ᵢ}^{PUCCH} for the ACK transmission corresponding to TB bundle Bᵢ may be determined as:

s_{B}_{₀}^{PUCCH}=max{m_{B}_{₀}^{PDSCH}+4,(L^{PDSCH}+2)} (1)

s_{B}_{ᵢ}^{PUCCH}=max{m_{B}_{ᵢ}^{PDSCH}+4,s_{B}_{ᵢ₋₁}^{PUCCH}+N_{abs,B}_{ᵢ₋₁}^{PUCCH}},i≠0 (2)

where m_{B}_{ᵢ}^{PDSCH} represents the last (absolute) subframe index for bundle Bᵢ; L^{PDSCH} represents the last (absolute) subframe index of the multi-TB transmission; N_{abs,B}_{ᵢ}^{PUCCH} represents the number of absolute subframes required to transmit the HARQ ACK for bundle Bᵢ.

For DL unicast with bundled HARQ feedback at least in the interleaving case, the timing relationship between PDSCH transmission and HARQ feedback may be the same in the full duplex-FDD (FD-FDD) case as in the HD-FDD case.

According to some conventional technologies, for a BL/CE UE, if the UE is configured with CEModeA, and if the UE is configured with higher layer parameter harq-Bundling in ce-PDSCH-MultiTB-Config and multiple TB are scheduled in the corresponding DCI format 6-1A with CRC scrambled by C-RNTI,
for HARQ-ACK transmission associated with the corresponding DCI, the UE shall generate M HARQ-ACK bits by performing a logical AND operation of HARQ-ACKs across all TBs in each TB bundle A_b where b=1, . . . , M;
the set of TBs that belong to TB bundle A_b and the number of TB bundles M are given by Table 1 below;
the value of N_{TB} is the number of scheduled TB determined in the corresponding DCI.

TABLE 1
Value of A_{b} and M for different values of DCI field ‘Multi-TB HARQ-ACK bundling
size’ and for different values of number of scheduled transport blocks N_{TB}

| DCI field | | | | | |
|---|---|---|---|---|---|
| ‘Multi-TB | | | | | |
| HARQ-ACK | | | | | |
| bundling | | | | | |
| size’ | N_{TB} = 1 | N_{TB} = 2 | N_{TB} = 4 | N_{TB} = 6 | N_{TB} = 8 |
| 00 | A₁ = {TB₀} | A₁ = {TB₀} | A₁ = {TB₀} | A₁ = {TB₀} | A₁ = {TB₀} |
| | | A₂ = {TB₁} | A₂ = {TB₁} | A₂ = {TB₁} | A₂ = {TB₁} |
| | | | A₃ = {TB₂} | A₃ = {TB₂} | A₃ = {TB₂} |
| | | | A₄ = {TB₃} | A₄ = {TB₃} | A₄ = {TB₃} |
| | | | | A₅ = {TB₄} | A₅ = {TB₄} |
| | | | | A₆ = {TB₅} | A₆ = {TB₅} |
| | | | | | A₇ = {TB₆} |
| | | | | | A₈ = {TB₇} |
| 01 | — | A₁ = {TB₀, TB₁} | A₁ = {TB₀, TB₁} | A₁ = {TB₀, TB₁} | A₁ = {TB₀, TB₁} |
| | | | A₂ = {TB₂, TB₃} | A₂ = {TB₂, TB₃} | A₂ = {TB₂, TB₃} |
| | | | | A₃ = {TB₄, TB₅} | A₃ = {TB₄, TB₅} |
| | | | | | A₄ = {TB₆, TB₇} |
| 10 | — | — | A₁ = {TB₀, TB₁} | A₁ = {TB₀, TB₁, TB₂} | A₁ = {TB₀, TB₁, TB₂} |
| | | | A₂ = {TB₂} | A₂ = {TB₃, TB₄, TB₅} | A₂ = {TB₃, TB₄, TB₅} |
| | | | A₃ = {TB₃} | | A₃ = {TB₆, TB₇} |
| 11 | — | — | A₁ = {TB₀, TB₁, TB₂, TB₃} | A₁ = {TB₀, TB₁, TB₂, TB₃} | A₁ = {TB₀, TB₁, TB₂, TB₃} |
| | | | | A₂ = {TB₄, TB₅} | A₂ = {TB₄, TB₅, TB₆, TB₇} |

According to conventional technologies, when receiving PDSCH scheduled by DCI format 1_1 or 1_2 in PDCCH with cyclic redundancy check (CRC) scrambled by cell radio network temporary identifier (C-RNTI), MCS-C-RNTI, or Configured Scheduling-RNTI (CS-RNTI) with NDI=1, if the UE is configured with pdsch-AggregationFactor in pdsch-config, the same symbol allocation is applied across the pdsch-AggregationFactor consecutive slots. When receiving PDSCH scheduled by DCI format 1_1 or 1_2 in PDCCH with CRC scrambled by CS-RNTI with NDI=0, or PDSCH scheduled without corresponding PDCCH transmission using sps-Config and activated by DCI format 1_1 or 1_2, the same symbol allocation is applied across the pdsch-AggregationFactor, in sps-Config if configured or in pdsch-config otherwise, consecutive slots. The UE may expect that the TB is repeated within each symbol allocation among each of the pdsch-AggregationFactor consecutive slots and the PDSCH is limited to a single transmission layer. For PDSCH scheduled by DCI format 1_1 or 1_2 in PDCCH with CRC scrambled by CS-RNTI with NDI=0, or PDSCH scheduled without corresponding PDCCH transmission using sps-Config and activated by DCI format 1_1 or 1_2, the UE is not expected to be configured with the time duration for the reception of pdsch-AggregationFactor repetitions, in sps-Config if configured or in pdsch-config otherwise, larger than the time duration derived by the periodicity P obtained from the corresponding sps-Config. The redundancy version to be applied on the n^{th} transmission occasion of the TB, where n=0, 1, . . . pdsch-AggregationFactor−1, is determined according to table 5.1.2.1-2 and “rv_{id} indicated by the DCI scheduling the PDSCH” in table 5.1.2.1-2 is assumed to be 0 for PDSCH scheduled without corresponding PDCCH transmission using sps-Config and activated by DCI format 1_1 or 1_2.

If a UE is configured with higher layer parameter repetitionNumber-r16 or if the UE is configured by repetitionScheme-r16 set to one of ‘FDMSchemeA’, ‘FDMSchemeB’ and ‘TDMSchemeA’, the UE does not expect to be configured with pdsch-AggregationFactor or pdsch-AggregationFactor-r16.

According to other conventional technologies, when a UE is configured by higher layer parameter RepetitionScheme-r16 set to one of ‘FDMSchemeA’, ‘FDMSchemeB’, ‘TDMSchemeA’, if the UE is indicated with two TCI states in a codepoint of the DCI field ‘Transmission Configuration Indication’ and DM-RS port(s) within one CDM group in the DCI field “Antenna Port(s)”.
When two TCI states are indicated in a DCI and the UE is set to ‘FDMSchemeA’, the UE shall receive a single PDSCH transmission occasion of the TB with each TCI state associated to a non-overlapping frequency domain resource allocation.
When two TCI states are indicated in a DCI and the UE is set to ‘FDMSchemeB’, the UE shall receive two PDSCH transmission occasions of the same TB with each TCI state associated to a PDSCH transmission occasion which has non-overlapping frequency domain resource allocation with respect to the other PDSCH transmission occasion.
When two TCI states are indicated in a DCI and the UE is set to ‘TDMSchemeA’, the UE shall receive two PDSCH transmission occasions of the same TB with each TCI state associated to a PDSCH transmission occasion which has non-overlapping time domain resource allocation with respect to the other PDSCH transmission occasion and both PDSCH transmission occasions shall be received within a given slot.

Moreover, when a UE is configured by the higher layer parameter repetitionNumber-r16 in PDSCH-TimeDomainResourceAllocation-r16, the UE may expect to be indicated with one or two TCI states in a codepoint of the DCI field ‘Transmission Configuration Indication’ together with the DCI field “Time domain resource assignment’ indicating an entry which contains repetitionNumber-r16 in PDSCH-TimeDomainResourceAllocation-r16 and DM-RS port(s) within one CDM group in the DCI field “Antenna Port(s)”.
When two TCI states are indicated in a DCI with ‘Transmission Configuration Indication’ field, the UE may expect to receive multiple slot level PDSCH transmission occasions of the same TB with two TCI states used across multiple PDSCH transmission occasions in the repetitionNumber-r16 consecutive slots.
When one TCI state is indicated in a DCI with ‘Transmission Configuration Indication’ field, the UE may expect to receive multiple slot level PDSCH transmission occasions of the same TB with one TCI state used across multiple PDSCH transmission occasions in the repetitionNumber-r16 consecutive slots.

When a UE is not indicated with a DCI that DCI field ‘Time domain resource assignment’ indicating an entry which contains repetitionNumber-r16 in PDSCH-TimeDomainResourceAllocation-r16, and it is indicated with two TCI states in a codepoint of the DCI field ‘Transmission Configuration Indication’ and DM-RS port(s) within two CDM groups in the DCI field “Antenna Port(s)”, the UE may expect to receive a single PDSCH where the association between the DM-RS ports and the TCI states are defined.

When a UE is not indicated with a DCI that DCI field ‘Time domain resource assignment’ indicating an entry which contains repetitionNumber-r16 in PDSCH-TimeDomainResourceAllocation-r16, and it is indicated with one TCI states in a codepoint of the DCI field ‘Transmission Configuration Indication’, the UE procedure for receiving the PDSCH upon detection of a PDCCH follows Clause 5.1 in 3GPP specification 38.214.

In some conventional technologies, a Type-1 HARQ-ACK codebook is determined based on the following factors:
PDSCH-to-HARQ_feedback timing values K1;
PDSCH time domain resource allocation (TDRA) table;
The ratio 2^{(μ}^{_{DL}}^{-μ}^{_{UL}}⁾ between the downlink SCS configuration μ_{DL} in and the uplink SCS configuration μ_{UL} if different numerology between DL and UL is configured;
Time Division Duplex (TDD) configuration by TDD-UL-DL-ConfigurationCommon and TDD-UL-DL-ConfigDedicated.

For example, the HARQ-ACK window size may be determined based on HARQ-ACK timing values K1, for example, K1={5, 6, 7}. For each K1, the candidate PDSCH reception occasions in each slot can be determined based on TDRA table and TDD configuration. Further, candidate PDSCH reception occasions in the time domain RA table overlapped with UL configured by TDD-UL-DL-ConfigurationCommon and TDD-UL-DL-ConfigDedicated are excluded. For overlapped candidate PDSCH reception occasions, only one HARQ-ACK bit is generated based on a particular rule.

Moreover, according to some conventional technologies, A UE reports HARQ-ACK information for a corresponding PDSCH reception or SPS PDSCH release only in a HARQ-ACK codebook that the UE transmits in a slot indicated by a value of a PDSCH-to-HARQfeedback timing indicator field in a corresponding DCI format 1_0 or DCI format 1_1. The UE reports NACK value(s) for HARQ-ACK information bit(s) in a HARQ-ACK codebook that the UE transmits in a slot not indicated by a value of a PDSCH-to-HARQfeedback timing indicator field in a corresponding DCI format 1_0 or DCI format 1_1.

If the UE is provided pdsch-AggregationFactor and no entry in pdsch-TimeDomainAllocationList includes RepNumR16 in PDSCH-TimeDomainResourceAllocation, N_{PDSCH}^{repeat} is a value of pdsch-AggregationFactor; otherwise N_{PDSCH}^{repeat}=1. The UE reports HARQ-ACK information for a PDSCH reception
from slot n−N_{PDSCH}^{repeat}+1 to slot n, if N_{PDSCH}^{repeat}>1, or
from slot n−RepNumR16+1 to slot n, if the Time domain resource assignment field in the DCI format scheduling the PDSCH reception indicates an entry in pdsch-TimeDomainAllocationList containing RepNumR16, or
in slot n, otherwise only in a HARQ-ACK codebook that the UE includes in a PUCCH or PUSCH transmission in slot n+k, where k is a number of slots indicated by the PDSCH-to-HARQfeedback timing indicator field in a corresponding DCI format or provided by dl-DataToUL-ACK if the PDSCH-to-HARQfeedback timing indicator field is not present in the DCI format. If the UE reports HARQ-ACK information for the PDSCH reception in a slot other than slot n+k, the UE sets a value for each corresponding HARQ-ACK information bit to NACK.

According to embodiments of the present disclosure, a solution for supporting repetitions for a plurality of downlink data transmission scheduled by signal downlink control information is proposed. A terminal device receives a repetition pattern configuration for the plurality of downlink data transmissions scheduled by single DCI and downlink control information scheduling a plurality of downlink data transmissions with repetitions from a network device. The downlink control information indicates a slot offset between the last repetition of the last downlink data transmission in the plurality of downlink data transmissions and a transmission of an uplink control channel. The terminal device determines a HARQ-ACK codebook for the plurality of downlink data transmissions based on a repetition pattern for the plurality of downlink data transmissions and the slot offset. The terminal device transmits a feedback for the repetitions for the downlink data transmissions based on the HARQ-ACK codebook to the network device. In this way, it achieves a flexible repetition patterns configuration for the plurality of downlink data transmissions scheduled by signal DCI, which improves the coverage/reliability performance for data transmission. Further, it enhances the HARQ-ACK feedback for multi-PDSCH scheduled by single DCI with the repetition pattern, which improves the downlink transmission reliability and spectrum efficiency.

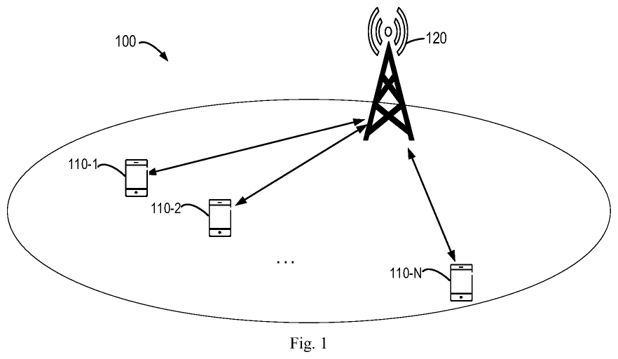

FIG. 1 illustrates a schematic diagram of a communication system in which embodiments of the present disclosure can be implemented. The communication system 100, which is a part of a communication network, comprises a terminal device 110-1, a terminal device 110-2, . . . , a terminal device 110-N, which can be collectively referred to as “terminal device(s) 110.” The number N can be any suitable integer number.

The communication system 100 further comprises network terminal device 120-1, a network device 120-2, . . . , a network device 120-M, which can be collectively referred to as “network device(s) 120.” In some embodiments, the network device may be gNB. Alternatively, the network device may be IAB. The number M can be any suitable integer number. In the communication system 100, the network devices 120 and the terminal devices 110 can communicate data and control information to each other. Only for the purpose of illustrations, the network device 120-1 can be regarded as a source network device and the network device 120-2 can be regarded as a target network device. The numbers of terminal devices and network devices shown in FIG. 1 are given for the purpose of illustration without suggesting any limitations.

Communications in the communication system 100 may be implemented according to any proper communication protocol(s), comprising, but not limited to, cellular communication protocols of the first generation (1G), the second generation (2G), the third generation (3G), the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Divided Multiple Address (CDMA), Frequency Divided Multiple Address (FDMA), Time Divided Multiple Address (TDMA), Frequency Divided Duplexer (FDD), Time Divided Duplexer (TDD), Multiple-Input Multiple-Output (MIMO), Orthogonal Frequency Divided Multiple Access (OFDMA) and/or any other technologies currently known or to be developed in the future.

Embodiments of the present disclosure can be applied to any suitable scenarios. For example, embodiments of the present disclosure can be implemented at reduced capability NR devices. Alternatively, embodiments of the present disclosure can be implemented in one of the followings: NR multiple-input and multiple-output (MIMO), NR sidelink enhancements, NR systems with frequency above 52.6 GHz, an extending NR operation up to 71 GHz, narrow band-Internet of Thing (NB-IOT)/enhanced Machine Type Communication (eMTC) over non-terrestrial networks (NTN), NTN, UE power saving enhancements, NR coverage enhancement, NB-IoT and LTE-MTC, Integrated Access and Backhaul (IAB), NR Multicast and Broadcast Services, or enhancements on Multi-Radio Dual-Connectivity.

The term “slot” used herein refers to a dynamic scheduling unit. One slot comprises a predetermined number of symbols. The term “downlink (DL) sub-slot” may refer to a virtual sub-slot constructed based on uplink (UL) sub-slot. The DL sub-slot may comprise fewer symbols than one DL slot. The slot used herein may refer to a normal slot which comprises a predetermined number of symbols and also refer to a sub-slot which comprises fewer symbols than the predetermined number of symbols.

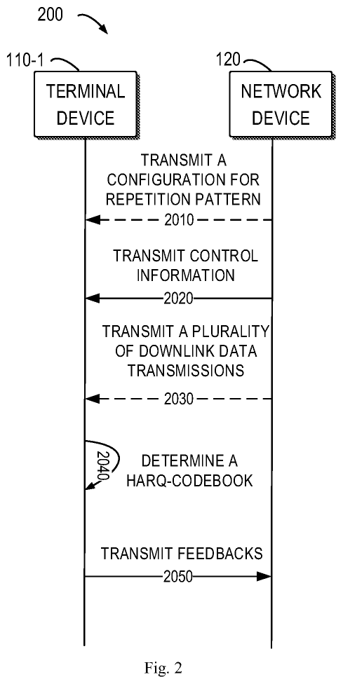

Embodiments of the present disclosure will be described in detail below. Reference is first made to FIG. 2, which shows a signaling chart illustrating process 200 among network devices according to some example embodiments of the present disclosure. Only for the purpose of discussion, the process 200 will be described with reference to FIG. 1. The process 200 may involve the terminal device 110-1 and the network device 120 in FIG. 1.

In some embodiments, the network device 120 may transmit 2010 a configuration for repetition pattern for a plurality of downlink data transmissions. In some embodiments, the configuration of the repetition pattern may be transmitted in DCI. Alternatively, the configuration of the repetition pattern may be transmitted via RRC signaling.

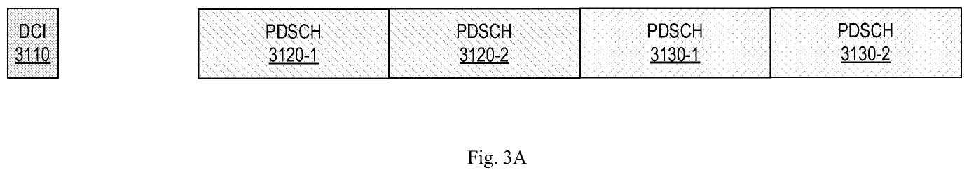

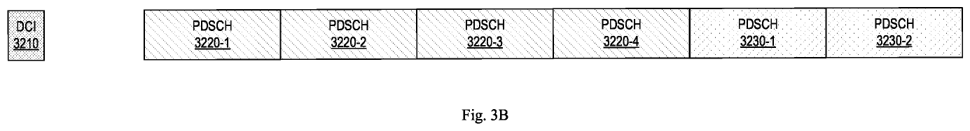

In an example embodiment, a type of the repetition pattern may comprise that all repetitions for each downlink data transmission in the plurality of downlink data transmissions are transmitted in continuous slots. In this way, it has less impact on the current 3GPP specification. In some embodiments, the number of repetitions for different downlink data transmissions may be the same. FIG. 3A illustrates a simplified block diagram of repetition patterns with the same number of repetitions according to some embodiments of the present disclosure. It should be noted that the number of repetitions and the number of downlink data transmissions are only examples not limitations.

As shown in FIG. 3A, the DCI 3110 may schedule two downlink data transmissions. The number of repetitions for the two downlink data transmissions is two. The first downlink data transmission may be transmitted on the PDSCH 3120-1 and the PDSCH 3120-2 which are in two continuous slots. The second downlink data transmission may be transmitted on the PDSCH 3130-1 and the PDSCH 3130-2 which are in tow continuous slots.

In other embodiments, the number of repetitions for different downlink data transmissions may be different. FIG. 3B illustrates a simplified block diagram of repetition patterns with different numbers of repetitions according to some embodiments of the present disclosure. It should be noted that the numbers of repetitions and the number of downlink data transmissions are only examples not limitations.

As shown in FIG. 3B, the DCI 3210 may schedule two downlink data transmissions. The number of repetitions for the first downlink data transmission is four and the number of repetitions for the second downlink data transmission is two. The first downlink data transmission may be transmitted on the PDSCH 3220-1, the PDSCH 3220-2, the PDSCH 3220-3 and the PDSCH 3220-4 which are in four continuous slots. The second downlink data transmission may be transmitted on the PDSCH 3230-1 and the PDSCH 3230-2 which are in two continuous slots.

In some embodiments, the network device 120 may transmit DCI which indicates the number of repetitions for each downlink data transmission. For example, a new field in DCI may be added to indicate the number of repetitions for each downlink data transmission. In other embodiments, the network device 120 may transmit a RRC configuration which indicates the number of repetitions for each downlink data transmission. Alternatively, the network device 120 may transmit a RRC configuration which indicates a table of a plurality of repetition patterns. The network device 120 may transmit another DCI which comprises an indication of the repetition pattern for a plurality of downlink data transmissions. Table 2 below shows an example of the table of the plurality of repetition patterns. It should be noted that numbers of the downlink data transmissions, the number of repetitions, and values shown in Table 2 are only examples not limitations.

TABLE 2

| RRC Configuration | | |
|---|---|---|
| 1^{st} downlink | 2^{nd} downlink | DCI Field |
| data | data | “Repetition |
| transmission | transmission | Indication” |

| | | |
|---|---|---|
| The number of | {2, 2} | 00 |
| downlink data | {4, 2} | 01 |
| transmissions | {2, 4} | 10 |
| is two. | {4, 4} | 11 |

Only as an example, if the other DCI comprises the repetition indication “00”, the terminal device 110-1 may determine that the number of repetitions for the first downlink data transmission is two and the number of repetitions for the second downlink data transmission is two. If the other DCI comprises the repetition indication “10”, the terminal device 110-1 may determine that the number of repetitions for the first downlink data transmission is two and the number of repetitions for the second downlink data transmission is four.

Alternatively, a type of the repetition pattern may comprise that one repetition for a group of the plurality of downlink data transmissions is transmitted in continuous slots. In this way, it achieves lower latency. For example, it is beneficial for Ultra-Reliable and Low Latency (URLLC) services.

In some embodiments, the network device 120 may transmit a RRC configuration which indicates that the group may comprise all scheduled downlink data transmissions. Alternatively, the RRC configuration received by the terminal device 110-1 may indicate that the group may comprise a subset of the plurality of downlink data transmissions.

In some embodiments, the network device 120 may transmit DCI which indicates the number of repetitions for each group of the plurality of downlink data transmissions. For example, a new field in DCI may be added to indicate the number of repetitions for group of the plurality of downlink data transmissions. In other embodiments, the network device 120 may transmit a RRC configuration which indicates the number of repetitions for each group of the plurality of downlink data transmissions. Alternatively, the network device 120 may transmit a RRC configuration which indicates a table of a plurality of repetition patterns. The network device 120 may transmit another DCI which comprises an indication of the repetition pattern for a plurality of downlink data transmissions.

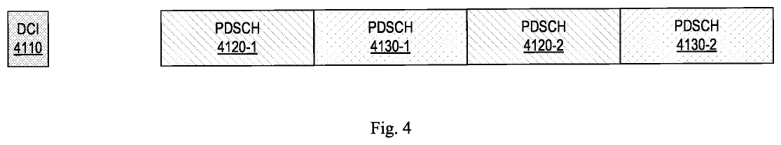

FIG. 4 illustrates a simplified block diagram of a repetition pattern according to some embodiments of the present disclosure. It should be noted that the numbers of repetitions and the number of downlink data transmissions are only examples not limitations.

As shown in FIG. 4, the DCI 4110 may schedule two downlink data transmissions. The number of repetitions for the first downlink data transmission is two and the number of repetitions for the second downlink data transmission is two. The first downlink data transmission may be transmitted on the PDSCH 4120 and the PDSCH 4120-2 which are not continuous slots. The second downlink data transmission may be transmitted on the PDSCH 4130-1 and the PDSCH 4130-2 which are not continuous slots.

In some embodiments, the type of the repetition pattern may be predetermined at the terminal device 110-1. For example, the repetition pattern where all repetitions for each downlink data transmission in the plurality of downlink data transmissions are transmitted in continuous slots may be predetermined at the terminal device 110-1. Alternatively, the type of the repetition pattern may be transmitted to the terminal device 110-1 in a RRC configuration. In other embodiments, the DCI may comprise an indication of the type of the repetition pattern. For example, if the type of the repetition pattern indicated by the DCI is that one repetition for the group of the plurality of downlink data transmissions is transmitted in continuous slots and the type of the repetition pattern currently configured at the terminal device is that all repetitions for each downlink data transmission in the plurality of downlink data transmissions are transmitted in continuous slots, the terminal device 110-1 may switch the type of repetition pattern based on the indication. In this way, it achieves dynamic switching.

Referring back to FIG. 2, the network device 120 transmits 2020 downlink control information to the terminal device 110-1. The downlink control information schedules a plurality of downlink data transmissions. For example, as shown in FIG. 3A, the DCI 3110 can schedule the downlink data transmission of TB #1 with two repetitions on PDSCHs 3120-1 and 3120-2 and the downlink data transmission of TB #2 with two repetitions on PDSCHs 3130-1 and 3130-2. The DCI 3210 may schedule the downlink data transmission of TB #1 with four repetitions on PDSCHs 3220-1, 3220-2, 3220-3 and 3220-4 and the downlink data transmission of TB #2 with two repetitions on PDSCHs 3230-1 and 3230-2, as shown in FIG. 3B. The DCI 4110 may schedule the downlink data transmission of TB #1 with two repetitions on PDSCHs 4120-1 and 4120-2 and the downlink data transmission of TB #2 with two repetitions on PDSCHs 4130-1 and 4130-2. The downlink control information indicates a slot offset between the last repetition of the last downlink data transmission in the plurality of downlink data transmissions and a transmission of an uplink control channel. The network device 120 may transmit 2030 the plurality of downlink data transmissions to the terminal device 110-1. The plurality of downlink data transmissions have repetitions.

The terminal device 110-1 determines 2040 a HARQ-ACK codebook for the plurality of downlink data transmissions based on the slot offset and the repetition pattern for the plurality of downlink data transmissions. In some embodiments, the terminal device 110-1 may generate a feedback for each downlink data transmission among the plurality of downlink data transmissions scheduled by the DCI. For example, the feedback may be an acknowledgment/non acknowledgment (A/N) bit. The feedback may be reported in the determined HARQ-ACK codebook on a PUCCH.

In some embodiments, the repetition pattern may indicate that all repetitions for each downlink data transmission the plurality downlink data transmissions are transmitted in continuous time slots. For example, if M downlink data transmissions of M TBs are scheduled by single DCI for the terminal device 110-1, slot based repetition for M TBs are configured and the number of repetition for all M TBs is N, the HARQ-ACK timing value indicated by DCI is slot offset k₁, the terminal device 110-1 may determine a further slot offset k₁′ for the m^{th} downlink data transmission to be (k₁+N*(M−m)), where the further slot offset is a slot offset between the last repetition of the m^{th} downlink data transmission and the transmission of an uplink control channel, the k₁′ can be regarded as the virtual HARQ-ACK timing value of the m^{th} downlink data transmission. N represents the number of repetitions for the plurality of downlink data transmissions, M represents the number of the plurality of downlink data transmissions, k₁ represents the slot offset, m is smaller than M, and N, M and m are integer numbers. The k₁′ values of for the M downlink data transmissions may be in the K1 set configured by RRC signaling. The terminal device 110-1 may determine the HARQ-ACK codebook for the M downlink data transmissions scheduled by the DCI with slot based repetition. In some embodiments, the terminal device 110-1 may determine a HARQ position for the m^{th} downlink data transmission on HARQ-ACK codebook based on the further slot offset k₁′.

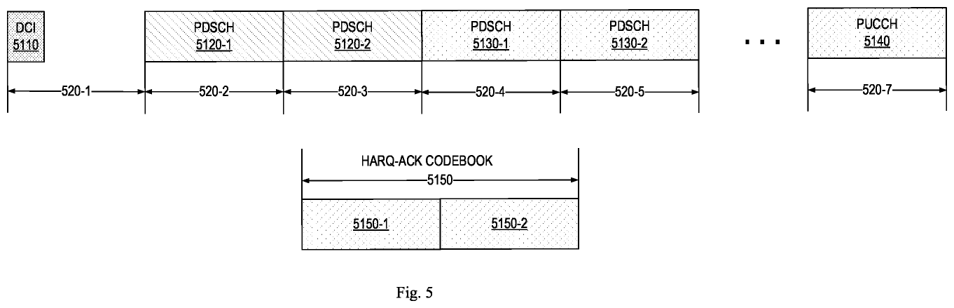

FIG. 5 illustrates a simplified block diagram of a type-1 HARQ-ACK codebook according to some embodiments of the present disclosure. As shown in FIG. 5, the DCI 5110 transmitted in slot 520-1 may schedule two downlink data transmissions (i.e., M=2). The number of repetitions for the two downlink data transmissions is two (i.e., N=2). The first downlink data transmission may be transmitted on PDSCH 5120-1 in slot 520-2 and PDSCH 5120-2 in slot 520-3. The second downlink data transmission may be transmitted on PDSCH 5130-1 in slot 520-4 and PDSCH 5130-2 in slot 520-5. The DCI may indicate that the slot offset is 2 (i.e., k₁=2). Since the last repetition of the last downlink transmission is in slot 520-5 and the slot offset is 2, the PUCCH 5140 for transmitting the feedback is in slot 520-7. For the 1^{st} downlink data transmission, the further slot offset may be (2+2*(2−1)) which equals to 4. In the HARQ-ACK codebook 5150, the HARQ-ACK position 5150-1 associated with the further slot offset value 4 may comprise the feedback for the first downlink data transmission in the slot 520-2 and the slot 520-3. If at least one PDSCH repetition among two PDSCH repetitions in the slot 520-2 and the slot 520-3 is successfully decoded, the terminal device 110-1 may report ACK for the first downlink data transmission, otherwise, the terminal device 110-1 may report NACK. The HARQ-ACK position 5150-2 associated with slot offset value 2 may comprise the feedback for the second downlink data transmission in the slot 520-4 and the slot 520-5. If at least one PDSCH repetition among two PDSCH repetitions in the slot 520-4 and the slot 520-5 is successfully decoded, the terminal device 110-1 may report ACK for the second downlink data transmission, otherwise, the terminal device 110-1 may report NACK. Table 3 below shows pseudo codes for Type-1 HARQ-ACK codebook determination.

```
TABLE 3
This Clause applies if the UE is configured with pdsch-HARQ-ACK-
Codebook = semi-static.
  [...]
  If the UE is provided pdsch-AggregationFactor in PDSCH-Config
and no entry in pdsch-TimeDomainAllocationList and pdsch-
TimeDomainAllocationListForDCI-Format1-2-r16 includes
repetitionNumber-r16 in PDSCH-TimeDomainResourceAllocation-r16,
when multiple PDSCHs are scheduled by a single DCI, the UE reports
HARQ-ACK information for the multiple PDSCH receptions which
is transmitted
  - from slot n − N_{PDSCH}^{repeat} * M + 1 to slot n , if N_{PDSCH}^{repeat} is
provided by pdsch-AggregationFactor [6, TS 38.214], M is the number of
PDSCHs scheduled by the DCI.
  only in a HARQ-ACK codebook that the UE includes in a PUCCH
or PUSCH transmission in slot n + k , where k is a number of slots
indicated by the PDSCH-to-HARQ_feedback timing indicator field in a
corresponding DCI format or provided by dl-DataToUL-ACK if the
PDSCH-to-HARQ_feedback timing indicator field is not present
in the DCI format. If the UE reports HARQ-ACK information for
the PDSCH reception in a slot other than slot n + k, the UE sets
a value for each corresponding HARQ-ACK information bit to NACK.
  When multiple PDSCHs are scheduled by a single DCI format and
pdsch-AggregationFactor in PDSCH-Config is provided, a location in
the Type-1 HARQ-ACK codebook for HARQ-ACK information
corresponding to a PDSCH m is based on the HARQ-ACK timing k′,
where k′=k + N_{PDSCH}^{repeat}*(M−m), m is the index of PDSCH from
{1,..., M}
```

In other embodiments, the repetition pattern may indicate that one repetition for a group of the plurality of downlink data transmissions is transmitted in continuous slots. For example, if M downlink data transmissions of M TBs are scheduled by single DCI for the terminal device 110-1, slot based repetition for M TBs are configured and the number of repetition for all M TBs is N, the HARQ-ACK timing value indicated by DCI is slot offset k₁, the terminal device 110-1 may determine a further slot offset k₁′ for the m^{th} downlink data transmission to be (k₁+M−m), where the further slot offset is a slot offset between the last repetition of the m^{th} downlink data transmission and the transmission of an uplink control channel, the k₁′ can be regarded as the virtual HARQ-ACK timing value of the m^{th} downlink data transmission. M represents the number of the plurality of downlink data transmissions, k₁ represents the slot offset, m is smaller than M, and N, M and m are integer numbers. The k₁′ values of for the M downlink data transmissions may be in the K1 set configured by RRC signaling. In some embodiments, the terminal device 110-1 may determine a Type-1 HARQ-ACK codebook for the plurality of downlink data transmissions with repetitions based on the HARQ-ACK timing set K1, the TDRA table and SCS configuration for downlink and uplink, the number of repetitions N, the number of the plurality of downlink data transmissions M and the TDD configuration. The terminal device 110-1 may determine a HARQ-ACK position on the Type-1 HARQ-ACK codebook for the m^{th} downlink data transmission based on the further slot offset k₁′. In some embodiments, the TDRA table may comprise a scheduling timing. The TDRA table may also comprise a start position. Alternatively or in addition, the TDRA table may comprise a length value. In other embodiments, the TDRA table may comprise the number of repetition.

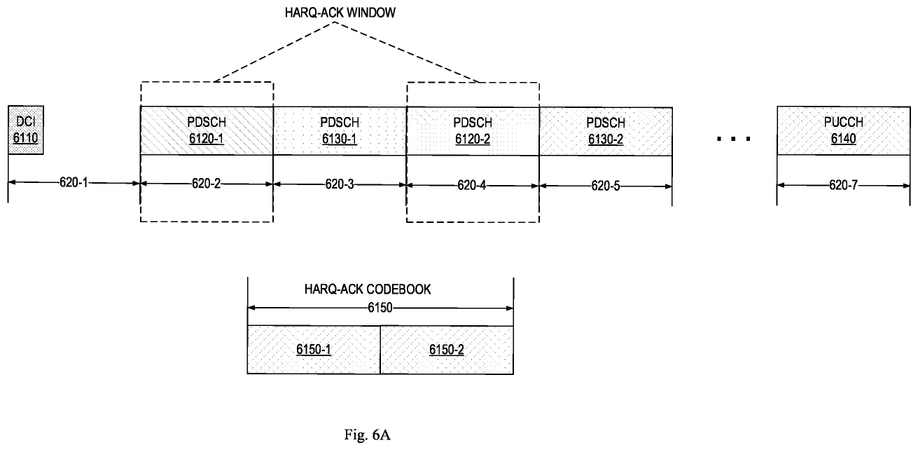

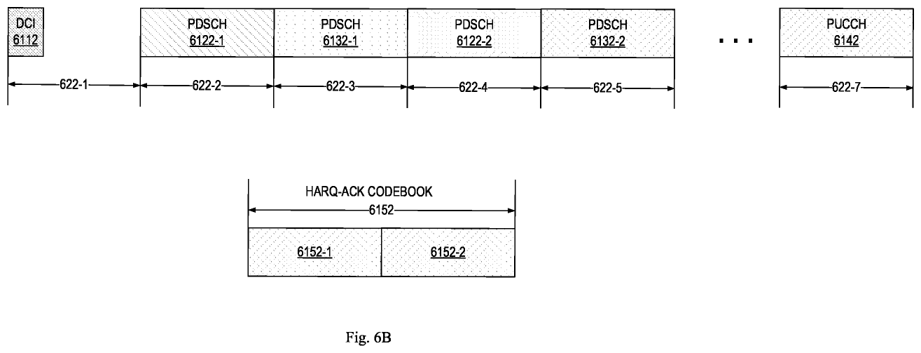

FIG. 6A illustrates a simplified block diagram of a type-1 HARQ-ACK codebook according to some embodiments of the present disclosure. As shown in FIG. 6A, the DCI 6110 transmitted in slot 620-1 may schedule two downlink data transmissions (i.e., M=2). The number of repetitions for the two downlink data transmissions is two (i.e., N=2). The first downlink data transmission may be transmitted on PDSCH 6120-1 in slot 620-2 and PDSCH 6120-2 in slot 620-4. The second downlink data transmission may be transmitted on PDSCH 6130-1 in slot 620-3 and PDSCH 6130-2 in slot 620-5. The DCI may indicate that the slot offset is 2 (i.e., k₁=2). Since the last repetition of the last downlink transmission is in slot 620-5 and the slot offset is 2, the PUCCH 6140 for transmitting the feedback is in slot 620-7. For the 1^{st} downlink data transmission, the further slot offset may be (2+(2-1)) which equals to 3. The HARQ-ACK codebook 6150 for the plurality of downlink data transmissions with repetitions may be determined based on the HARQ-ACK timing set K1, the TDRA table and SCS configuration for downlink and uplink, the number of repetitions N, the number of the plurality of downlink data transmissions M and the TDD configuration. In the HARQ-ACK codebook 6150, the HARQ-ACK position 6150-1 associated with the further slot offset value 3 may comprise the feedback for the first downlink data transmission in the slot 620-2 and the slot 620-4. The HARQ-ACK position 6150-2 associated with the slot offset value 2 may comprise the feedback for the second downlink data transmission in the slot 620-3 and the slot 620-5.

In some embodiments, the terminal device 110-1 may determine a HARQ-ACK window for the m^{th} downlink data transmission. The HARQ-ACK window may comprise a plurality of discontinuous slots. If at least one slot in the plurality of discontinuous slots has valid downlink symbols for the m^{th} downlink data transmission, the terminal device 110-1 may generate the HARQ-ACK position for the m^{th} downlink data transmission. As shown in FIG. 6A, the HARQ-ACK window for the first downlink data transmission may comprise the slots 620-2 and 620-4. If the slot 620-2 is configured as an uplink slot and the slot 620-4 is configured as an uplink slot, the terminal device 110-1 may not determine a HARQ-ACK position for the first downlink data transmission. If at least one of the slots 620-2 and 620-4 is configured as a downlink slot, the terminal device 110-1 may determine a HARQ-ACK position for the first downlink data transmission. Tables 4 and 5 below show pseudo codes for Type-1 HARQ-ACK codebook determination.

```
TABLE 4
  This Clause applies if the UE is configured with pdsch-HARQ-ACK-
Codebook = semi-static.
  [...]
  If the UE is provided pdsch-AggregationFactor in PDSCH-Config
and no entry in pdsch-TimeDomainAllocationList and pdsch-
TimeDomainAllocationListForDCI-Format1-2-r16 includes
repetitionNumber-r16 in PDSCH-TimeDomainResourceAllocation-r16,
when multiple PDSCHs are scheduled by a single DCI, the UE reports
HARQ-ACK information for the multiple PDSCH receptions which
is transmitted
  - from slot n − N_{PDSCH}^{repeat} * M + 1 to slot n , if N_{PDSCH}^{repeat} is
provided by pdsch-AggregationFactor [6, TS 38.214], M is the number of
PDSCHs scheduled by the DCI.
  only in a HARQ-ACK codebook that the UE includes in a PUCCH
or PUSCH transmission in slot n + k, where k is a number of slots
indicated by the PDSCH-to-HARQ_feedback timing indicator field in a
corresponding DCI format or provided by dl-DataToUL-ACK if the
PDSCH-to-HARQ_feedback timing indicator field is not present
in the DCI format. If the UE reports HARQ-ACK information for
the PDSCH reception in a slot other than slot n + k, the UE sets
a value for each corresponding HARQ-ACK information bit to NACK.
  When multiple PDSCHs are scheduled by a single DCI format and
pdsch-AggregationFactor in PDSCH-Config is provided, a location in
the Type-1 HARQ-ACK codebook for HARQ-ACK information
corresponding to a PDSCH m is based on the HARQ-ACK timing k′,
where k′=k+(M−m), m is the index of PDSCH from {1,..., M}
  [...]
```

```
TABLE 5
while r < [symbol]   (R)
  if the UE is provided tdd-UL-DL-ConfigurationCommon, or tdd-UL-DL-
  ConfigurationDedicated and,
  n=1, n′=0;
  while n<= N_{PDSCH}^{repeat} ,
      for slot └(n_{U} − K_{1,k} ) · 2^{μDL -μUL} ┘ + n_{D} − M * N_{PDSCH}^{repeat} −1),
      if at least one symbol of the PDSCH time resource derived by row r is
      configured as UL where K_{1,k} is the k-th slot timing value in set K₁ ,
            n′=n′+1;
          end if
    n=n+1;
    end while
    if n′ = N_{PDSCH}^{repeat} ,
        R = R\r ;
  else
        r = r + 1 ;
  end if
end while
```

In other embodiments, the repetition pattern may indicate that one repetition for a group of the plurality of downlink data transmissions is transmitted in continuous slots. For example, if M downlink data transmissions of M TBs are scheduled by single DCI for the terminal device 110-1, slot based repetition for M TBs are configured and the number of repetition for all M TBs is N, the HARQ-ACK timing value indicated by DCI is slot offset k₁, the terminal device 110-1 may determine a further slot offset k₁′ for the m^{th} downlink data transmission to be (k₁+M−m), where the further slot offset is a slot offset between the last repetition of the m^{th} downlink data transmission and the transmission of an uplink control channel, the k₁′ can be regarded as the virtual HARQ-ACK timing value of the m^{th} downlink data transmission. M represents the number of the plurality of downlink data transmissions, k₁ represents the slot offset, m is smaller than M, and N, M and m are integer numbers. The k₁′ values of for the M downlink data transmissions may be in the K1 set configured by RRC signaling. In some embodiments, the terminal device 110-1 may determine a Type-1 HARQ-ACK codebook for the plurality of downlink data transmissions with repetitions based on the HARQ-ACK timing set K1, the TDRA table and SCS configuration for downlink and uplink. The terminal device 110-1 may determine a HARQ-ACK position on the Type-1 HARQ-ACK codebook for the m^{th} downlink data transmission based on the further slot offset k₁′. In this way, it can support the base station flexible scheduling of multiple PDSCHs by single DCI, since when M is dynamically changed, a HARQ-ACK position can be ensured always on the HARQ-ACK codebook.

FIG. 6B illustrates a simplified block diagram of a type-1 HARQ-ACK codebook according to some embodiments of the present disclosure. As shown in FIG. 6B, the DCI 6112 transmitted in slot 622-1 may schedule two downlink data transmissions (i.e., M=2). The number of repetitions for the two downlink data transmissions is two (i.e., N=2). The first downlink data transmission may be transmitted on PDSCH 6122-1 in slot 622-2 and PDSCH 6122-2 in slot 622-4. The second downlink data transmission may be transmitted on PDSCH 6132-1 in slot 622-3 and PDSCH 6132-2 in slot 622-5. The DCI may indicate that the slot offset is 2 (i.e., k₁=2). Since the last repetition of the last downlink transmission is in slot 622-5 and the slot offset is 2, the PUCCH 6142 for transmitting the feedback is in slot 622-7. For the 1^{st} downlink data transmission, the further slot offset may be (2+(2−1)) which equals to 3. The HARQ-ACK codebook 6152 for the plurality of downlink data transmissions with repetitions may be based on the HARQ-ACK timing set K1, the TDRA table and SCS configuration for downlink and uplink. In the HARQ-ACK codebook 6152, the HARQ-ACK position 6152-1 associated with the further slot offset value 3 may comprise the feedback for the first downlink data transmission in the slot 622-2 and the slot 622-4. The HARQ-ACK position 6152-2 associated with the slot offset value 2 may comprise the feedback for the second downlink data transmission in the slot 622-3 and the slot 622-5.

In some embodiments, the repetition pattern may indicate that one repetition for a group of the plurality of downlink data transmissions is transmitted in continuous slots and the numbers of repetitions for the plurality of downlink data transmissions are different. For example, if M downlink data transmissions with repetition are scheduled for the terminal device 110-1, the numbers of repetitions for the M downlink data transmissions are {N₁, . . . , Nₘ, . . . , Nₘ}, the slot offset in the DCI is k₁, the terminal device 110-1 may determine a further slot offset kin for the m^{th} downlink data transmission to be (k₁+Σᵢ₌ₘ₊₁^{M}Nᵢ), where the further slot offset is a slot offset between the last repetition of the m^{th} downlink data transmission and the transmission of an uplink control channel, Nᵢ represents the number of repetitions for the i^{th} downlink data transmission in the plurality of downlink data transmissions, M represents the number of the plurality of downlink data transmissions, k₁ represents the slot offset, N, M, i and m are integer numbers, and m is smaller than M. The k₁′ values for the M downlink data transmissions may be in the K1 set configured by RRC signaling. In some embodiments, the terminal device 110-1 may determine a HARQ-ACK position for the m^{th} downlink data transmission based on the further slot offset k₁^{m}, the number of repetitions Nm for the m^{th} downlink data transmission, the number of plurality of PDSCHs M and a TDD configuration.

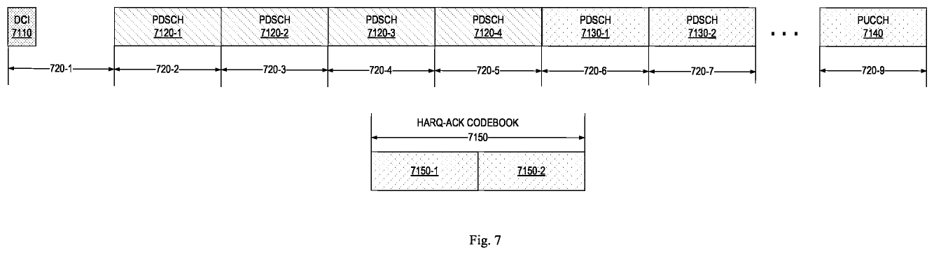

FIG. 7 illustrates a simplified block diagram of a type-1 HARQ-ACK codebook according to some embodiments of the present disclosure. As shown in FIG. 7, the DCI 7110 transmitted in slot 720-1 may schedule two downlink data transmissions (i.e., M=2). The number of repetitions for the first downlink data transmission is four (i.e., N₁=4) and the number of repetitions for the second downlink data transmission is two (i.e., N₂=2). The first downlink data transmission may be transmitted on PDSCH 7120-1 in slot 720-2, PDSCH 7120-2 in slot 720-3, PDSCH 7120-3 in slot 720-4 and PDSCH 7120-4 in slot 720-5. The second downlink data transmission may be transmitted on PDSCH 7130-1 in slot 720-6 and PDSCH 7130-2 in slot 720-7. The DCI may indicate that the slot offset is 2 (i.e., k₁=2). Since the last repetition of the last downlink transmission is in slot 720-7 and the slot offset is 2, the PUCCH 7140 for transmitting the feedback is in slot 720-9 For the 1^{st} downlink data transmission, the further slot offset k₁¹ may be (2+Σᵢ₌₁₊₁²Nᵢ) which equals to 4. In the HARQ-ACK codebook 7150, the HARQ-ACK position 7150-1 may comprise the feedback for the 1^{st} downlink data transmission. If at least one of repetitions of the 1^{st} downlink data transmission in the slot 720-2, the slot 720-3, the slot 720-4 and the slot 720-5 is successfully decoded, the terminal device 110-1 may generate ACK for the 1^{st} downlink data transmission, otherwise, the terminal device 110-1 may generate NACK. The HARQ-ACK position 7150-2 may comprise the feedback for the 2^{nd} downlink data transmission. If at least one of repetitions of the 2^{nd} downlink data transmission in the slot 720-6 or the slot 720-7 is successfully decoded, the terminal device 110-1 may generate ACK for the 2^{nd} downlink data transmission, otherwise, the terminal device 110-1 may generate NACK.

Referring back to FIG. 2, the terminal device 110-1 transmits 2050 the HARQ-ACK codebook comprising feedbacks for the plurality of downlink data transmissions. The HARQ-ACK codebook is transmitted on the uplink control channel. For example, as shown in FIG. 5, the feedback may be transmitted on the PUCCH 5140 and the feedback may be transmitted on the PUCCH 6140 as shown in FIG. 6A. The feedback may be transmitted on the PUCCH 7140 as shown in FIG. 7. Table 6 below shows pseudo codes for Type-1 HARQ-ACK codebook determination.

```
TABLE 6
  This Clause applies if the UE is configured with pdsch-HARQ-ACK-
Codebook = semi-static.
  [...]
  If the UE is provided pdsch-AggregationFactor in PDSCH-Config
and no entry in pdsch-TimeDomainAllocationList and pdsch-
TimeDomainAllocationListForDCI-Format1-2-r16 includes
repetitionNumber-r16 in PDSCH-TimeDomainResourceAllocation-r16,
when multiple PDSCHs are scheduled by a single DCI, the UE reports
HARQ-ACK information for the multiple PDSCH receptions which
is transmitted
  - from slot n − Σᵢ₌₁^{M} Nᵣₑₚ_{ᵢ} + 1 to slot n, if Nᵣₑₚ_{ᵢ} is provided for
PDSCH i [6, TS 38.214], M is the number of PDSCHs scheduled
by the DCI.
  only in a HARQ-ACK codebook that the UE includes in a PUCCH
or PUSCH transmission in slot n + k, where k is a number of slots
indicated by the PDSCH-to-HARQ_feedback timing indicator field in a
corresponding DCI format or provided by dl-DataToUL-ACK if the
PDSCH-to-HARQ_feedback timing indicator field is not present
in the DCI format. If the UE reports HARQ-ACK information for
the PDSCH reception in a slot other than slot n + k, the UE sets
a value for each corresponding HARQ-ACK information bit to NACK.
  When multiple PDSCHs are scheduled by a single DCI format and
slot based repetition for the multiple PDSCHs is configured, a
location in the Type-1 HARQ-ACK codebook for HARQ-ACK
information corresponding to a PDSCH m is based on the HARQ-ACK
timing k′ where k′ₘ= k + Σᵢ₌ₘ₊₁^{M} N_repᵢ , m is the index of PDSCH
from {1,..., M−1}, k′_{M}=k.
  [...]
```

In some embodiments, the HARQ-ACK for the plurality of downlink data transmissions scheduled by single DCI may have same priority and the priority index may be indicated in the priority indicator in the DCI.

In other embodiments, the HARQ-ACK for the plurality of downlink data transmissions scheduled by single DCI may have different priorities and the priority indicator field in DL DCI 1_1/1_2/new DCI format may be extended to separately indicate priority for HARQ-ACK for each downlink data transmission or downlink data transmission set.

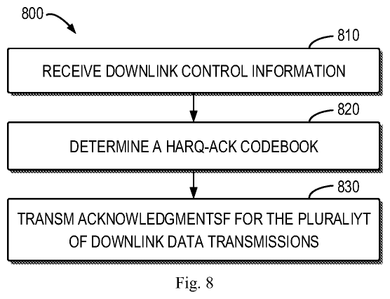

FIG. 8 shows a flowchart of an example method 800 in accordance with an embodiment of the present disclosure. The method 800 can be implemented at any suitable devices. Only for the purpose of illustrations, the method 800 can be implemented at a terminal device 110-1 as shown in FIG. 1.

In some embodiments, the terminal device 110-1 may receive a configuration for repetition pattern for a plurality of downlink data transmissions. In some embodiments, the configuration of the repetition pattern may be transmitted in DCI. Alternatively, the configuration of the repetition pattern may be transmitted via RRC signaling.

In an example embodiment, a type of the repetition pattern may comprise that all repetitions for each downlink data transmission in the plurality of downlink data transmissions are transmitted in continuous slots. In this way, it has less impact on the current 3GPP specification. In some embodiments, the number of repetitions for different downlink data transmissions may be the same. In other embodiments, the number of repetitions for different downlink data transmissions may be different.

In some embodiments, the terminal device 110-1 may receive DCI which indicates the number of repetitions for each downlink data transmission. For example, a new field in DCI may be added to indicate the number of repetitions for each downlink data transmission. In other embodiments, the network device 120 may transmit a RRC configuration which indicates the number of repetitions for each downlink data transmission. Alternatively, the terminal device 110-1 may receive a RRC configuration which indicates a table of a plurality of repetition patterns. The terminal device 110-1 may receive another DCI which comprises an indication of the repetition pattern for a plurality of downlink data transmissions.

Alternatively, a type of the repetition pattern may comprise that one repetition for a group of the plurality of downlink data transmissions is transmitted in continuous slots. In this way, it achieves lower latency. For example, it is beneficial for Ultra-Reliable and Low Latency (URLLC) services.

In some embodiments, the terminal device 110-1 may receive a RRC configuration which indicates that the group may comprise all scheduled downlink data transmissions. Alternatively, the RRC configuration received by the terminal device 110-1 may indicate that the group may comprise a subset of the plurality of downlink data transmissions.

In some embodiments, the terminal device 110-1 may receive DCI which indicates the number of repetitions for each downlink data transmission. For example, a new field in DCI may be added to indicate the number of repetitions for each downlink data transmission. In other embodiments, the terminal device 110-1 may receive a RRC configuration which indicates the number of repetitions for each downlink data transmission. Alternatively, the terminal device 110-1 may receive a RRC configuration which indicates a table of a plurality of repetition patterns. The terminal device 110-1 may receive transmit another DCI which comprises an indication of the repetition pattern for a plurality of downlink data transmissions.

In some embodiments, the type of the repetition pattern may be predetermined at the terminal device 110-1. For example, the repetition pattern where all repetitions for each downlink data transmission in the plurality of downlink data transmissions are transmitted in continuous slots may be predetermined at the terminal device 110-1. Alternatively, the type of the repetition pattern may be transmitted to the terminal device 110-1 in a RRC configuration. In other embodiments, the DCI may comprise an indication of the type of the repetition pattern. For example, if the type of the repetition pattern indicated by the DCI is that one repetition for the group of the plurality of downlink data transmissions is transmitted in continuous slots and the type of the repetition pattern currently configured at the terminal device is that all repetitions for each downlink data transmission in the plurality of downlink data transmissions are transmitted in continuous slots, the terminal device 110-1 may switch the type of repetition pattern based on the indication. In this way, it achieves dynamic switching.

At block 810, the terminal device 110-1 receives downlink control information scheduling a plurality of downlink data transmissions with repetitions from the second device 120. The downlink control information indicates a slot offset between the last repetition of the last downlink data transmission in the plurality of downlink data transmissions and a transmission of an uplink control channel.

At block 820, the terminal device 110-1 determines a HARQ-ACK codebook for the plurality of downlink data transmissions based on the slot offset and the repetition pattern for the plurality of downlink data transmissions. In some embodiments, the terminal device 110-1 may generate a feedback for each downlink data transmission among the plurality of downlink data transmissions scheduled by the DCI. For example, the feedback may be an acknowledgment/non acknowledgment (A/N) bit. The feedback may be reported in the determined HARQ-ACK codebook.

In some embodiments, the repetition pattern may indicate that all repetitions for each downlink data transmission the plurality downlink data transmissions are transmitted in continuous time slots. For example, if the terminal device 110-1 is scheduled by M downlink data transmissions by single DCI with slot repetition number N and the slot offset in the DCI is k₁, the terminal device 110-1 may determine a further slot offset k₁′ for the m^{th} downlink data transmission to be (k₁+N*(M−m)), where N represents the number of repetitions for the plurality of downlink data transmissions, M represents the number of the plurality of downlink data transmissions, k₁ represents the slot offset, m is smaller than M, and N, M and m are integer numbers. The k₁′ values of for the M downlink data transmissions may be in the K1 set configured by RRC signaling. The terminal device 110-1 may determine the HARQ-ACK codebook for the M downlink data transmissions scheduled by the DCI with slot based repetition. In some embodiments, the terminal device 110-1 may determine a HARQ position for the m^{th} downlink data transmission based on the further slot offset.

In other embodiments, the repetition pattern may indicate that one repetition for a group of the plurality of downlink data transmissions is transmitted in continuous slots. For example, if the terminal device 110-1 is scheduled by M downlink data transmissions by single DCI with slot repetition number N and the slot offset in the DCI is k₁, the terminal device 110-1 may determine a further slot offset k₁′ for the m^{th} downlink data transmission to be (k₁+M−m), where M represents the number of the plurality of downlink data transmissions, k₁ represents the slot offset, m is smaller than M, and N, M and m are integer numbers. The k₁′ values of for the M downlink data transmissions may be in the K1 set configured by RRC signaling. In some embodiments, the terminal device 110-1 may determine a HARQ-ACK position for the m^{th} downlink data transmission based on the further slot offset k₁′, the number of repetitions N, the number of the plurality of downlink data transmissions M and a TDD configuration.

In some embodiments, the terminal device 110-1 may determine a HARQ-ACK window for the m^{th} downlink data transmission. The HARQ-ACK window may comprise a plurality of discontinuous slots. If at least one slot in the plurality of discontinuous slots is configured as a downlink slot, the terminal device 110-1 may determine the HARQ-ACK position for the m^{th} downlink data transmission.

n some embodiments, the repetition pattern may indicate that one repetition for a group of the plurality of downlink data transmissions is transmitted in continuous slots and the numbers of repetitions for the plurality of downlink data transmissions are different. For example, if the terminal device 110-1 is scheduled by M downlink data transmissions with repetition, the numbers of repetitions for the M downlink data transmissions are {N₁, . . . , Nₘ, . . . , N_{M}}, the slot offset in the DCI is k₁, the terminal device 110-1 may determine a further slot offset k₁^{m} for the m^{th} downlink data transmission to be (k₁+Σᵢ₌ₘ₊₁^{M}Nᵢ), where Nᵢ represents the number of repetitions for the i^{th} downlink data transmission in the plurality of downlink data transmissions, M represents the number of the plurality of downlink data transmissions, k₁ represents the slot offset, N, M, i and m are integer numbers, and m is smaller than M. The k₁′ values for the M downlink data transmissions may be in the K1 set configured by RRC signaling. In some embodiments, the terminal device 110-1 may determine a HARQ-ACK position for the m^{th} downlink data transmission based on the further slot offset kin, the number of repetitions Nm for the m^{th} downlink data transmission, the number of plurality of PDSCHs M and a TDD configuration.

At block 830, the terminal device 110-1 transmits the HARQ-ACK codebook comprising feedbacks for the plurality of downlink data transmissions. The HARQ-ACK codebook is transmitted on the uplink control channel. In some embodiments, the plurality of downlink data transmissions may have a same priority and the priority is indicated in the downlink control information. Alternatively, the plurality of downlink data transmissions may have different priorities and the different priorities are indicated in the downlink control information. In other embodiments, the acknowledgments for the plurality of downlink data transmissions may have a same priority and the priority may be indicated in the downlink control information. Alternatively, the acknowledgments for the plurality of downlink data transmissions may have different priorities and the different priorities may be indicated in the downlink control information.

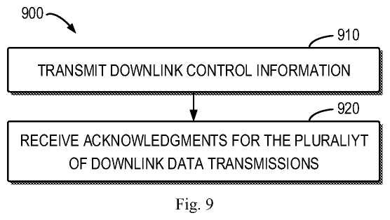

FIG. 9 shows a flowchart of an example method 900 in accordance with an embodiment of the present disclosure. The method 900 can be implemented at any suitable devices. Only for the purpose of illustrations, the method 900 can be implemented at a first network device 120 as shown in FIG. 1.

In some embodiments, the network device 120 may transmit a configuration or repetition pattern for a plurality of downlink data transmissions. In some embodiments, the configuration of the repetition pattern may be transmitted in DCI. Alternatively, the configuration of the repetition pattern may be transmitted via RRC signaling.

In an example embodiment, a type of the repetition pattern may comprise that all repetitions for each downlink data transmission in the plurality of downlink data transmissions are transmitted in continuous slots. In this way, it has less impact on the current 3GPP specification. In some embodiments, the number of repetitions for different downlink data transmissions may be the same. In other embodiments, the number of repetitions for different downlink data transmissions may be different.

In some embodiments, the network device 120 may transmit DCI which indicates the number of repetitions for each downlink data transmission. For example, a new field in DCI may be added to indicate the number of repetitions for each downlink data transmission. In other embodiments, the network device 120 may transmit a RRC configuration which indicates the number of repetitions for each downlink data transmission. Alternatively, the network device 120 may transmit a RRC configuration which indicates a table of a plurality of repetition patterns. The network device 120 may transmit another DCI which comprises an indication of the repetition pattern for a plurality of downlink data transmissions.

Alternatively, a type of the repetition pattern may comprise that one repetition for a group of the plurality of downlink data transmissions is transmitted in continuous slots. In this way, it achieves lower latency. For example, it is beneficial for Ultra-Reliable and Low Latency (URLLC) services.

In some embodiments, the network device 120 may transmit a RRC configuration which indicates that the group may comprise all scheduled downlink data transmissions. Alternatively, the RRC configuration received by the terminal device 110-1 may indicate that the group may comprise a subset of the plurality of downlink data transmissions.

In some embodiments, the network device 120 may transmit DCI which indicates the number of repetitions for each downlink data transmission. For example, a new field in DCI may be added to indicate the number of repetitions for each downlink data transmission. In other embodiments, the network device 120 may transmit a RRC configuration which indicates the number of repetitions for each downlink data transmission. Alternatively, the network device 120 may transmit a RRC configuration which indicates a table of a plurality of repetition patterns. The network device 120 may transmit another DCI which comprises an indication of the repetition pattern for a plurality of downlink data transmissions.

In some embodiments, the type of the repetition pattern may be predetermined at the terminal device 110-1. For example, the repetition pattern where all repetitions for each downlink data transmission in the plurality of downlink data transmissions are transmitted in continuous slots may be predetermined at the terminal device 110-1. Alternatively, the type of the repetition pattern may be transmitted to the terminal device 110-1 in a RRC configuration. In other embodiments, the DCI may comprise an indication of the type of the repetition pattern. For example, if the type of the repetition pattern indicated by the DCI is that one repetition for the group of the plurality of downlink data transmissions is transmitted in continuous slots and the type of the repetition pattern currently configured at the terminal device is that all repetitions for each downlink data transmission in the plurality of downlink data transmissions are transmitted in continuous slots, the terminal device 110-1 may switch the type of repetition pattern based on the indication. In this way, it achieves dynamic switching.

At block 910, the network device 120 transmits downlink control information scheduling a plurality of downlink data transmissions with repetitions from the second device 120. The downlink control information indicates a slot offset between the last repetition of the last downlink data transmission in the plurality of downlink data transmissions and a transmission of an uplink control channel.

At block 920, the network device 120 receives the HARQ-ACK codebook comprising feedbacks for the plurality of downlink data transmissions. The HARQ-ACK codebook is transmitted on the uplink control channel. In some embodiments, the plurality of downlink data transmissions may have a same priority and the priority is indicated in the downlink control information. Alternatively, the plurality of downlink data transmissions may have different priorities and the different priorities are indicated in the downlink control information. In other embodiments, the acknowledgments for the plurality of downlink data transmissions may have a same priority and the priority may be indicated in the downlink control information. Alternatively, the acknowledgments for the plurality of downlink data transmissions may have different priorities and the different priorities may be indicated in the downlink control information.

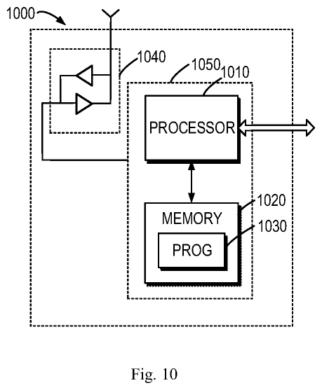

FIG. 10 is a simplified block diagram of a device 1000 that is suitable for implementing embodiments of the present disclosure. The device 1000 can be considered as a further example implementation of the terminal device 110 and the network device 120 as shown in FIG. 1. Accordingly, the device 1000 can be implemented at or as at least a part of the terminal device 110 or the network device 120.

As shown, the device 1000 includes a processor 1010, a memory 1020 coupled to the processor 1010, a suitable transmitter (TX) and receiver (RX) 1040 coupled to the processor 1010, and a communication interface coupled to the TX/RX 1040. The memory 1020 stores at least a part of a program 1030. The TX/RX 1040 is for bidirectional communications. The TX/RX 1040 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1030 is assumed to include program instructions that, when executed by the associated processor 1010, enable the device 1000 to operate in accordance with the embodiments of the present disclosure, as discussed herein with reference to FIGS. 2 to 9. The embodiments herein may be implemented by computer software executable by the processor 1010 of the device 1000, or by hardware, or by a combination of software and hardware. The processor 1010 may be configured to implement various embodiments of the present disclosure. Furthermore, a combination of the processor 1010 and memory 1020 may form processing means 850 adapted to implement various embodiments of the present disclosure.

The memory 1020 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1020 is shown in the device 1000, there may be several physically distinct memory modules in the device 1000. The processor 1010 may be of any type suitable to the local technical network, and may include one or more of general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

In some embodiments, a terminal device comprises circuitry configured to: receive, at a terminal device and from a network device, downlink control information scheduling a plurality of downlink data transmissions with repetitions, the downlink control information indicating a slot offset between the last repetition of the last downlink data transmission in the plurality of downlink data transmissions and a transmission of an uplink control channel; determine, based on the slot offset and a repetition pattern for the plurality of downlink data transmissions, a hybrid automatic repeat request acknowledgment (HARQ-ACK) codebook for the plurality of downlink data transmissions; and transmit, to the network device and on the uplink control channel, the HARQ-ACK codebook comprising feedbacks for the plurality of downlink data transmissions.

In some embodiments, the repetition pattern indicates that all repetitions for each downlink data transmission the plurality downlink data transmissions are transmitted in continuous time slots and the terminal device comprises circuitry configured to determine the HARQ-ACK codebook by for a m^{th} downlink data transmission in the plurality of downlink data transmissions, determining a further slot offset k₁′ to be the (k1+N*(M−m)), wherein the further slot offset is a slot offset between the last repetition of the m^{th} downlink data transmission and the transmission of an uplink control channel, N represents the number of repetitions for the plurality of downlink data transmissions, M represents the number of the plurality of downlink data transmissions, k1 represents the slot offset, is smaller than M, and N, M and m are integer numbers; and determining a HARQ-ACK position for the m^{th} downlink data transmission in the HARQ-ACK codebook based on the further slot offset k₁′.

In some embodiments, the repetition pattern indicates t that one repetition for a group of the plurality of downlink data transmissions is transmitted in continuous time slots and the terminal device comprises circuitry configured to determine the HARQ-ACK codebook by: for a m^{th} downlink data transmission in the plurality of downlink data transmissions, determining a further slot offset k₁′ to be the (k1+M−m), wherein the further slot offset is a slot offset between the last repetition of the m^{th} downlink data transmission and the transmission of an uplink control channel, N represents the number of repetitions for the plurality of downlink data transmissions, M represents the number of the plurality of downlink data transmissions, k1 represents the slot offset, m is smaller than M, and N, M and m are integer numbers; and determining a HARQ-ACK position for the m^{th} downlink data transmission in the HARQ-ACK codebook based on the further slot offset k₁′.

In some embodiments, the terminal device comprises circuitry configured to determine the HARQ-ACK codebook for the plurality of downlink data transmissions by determining the HARQ-ACK codebook based on a HARQ-ACK timing set, a time domain resource allocation (TDRA) table, a subcarrier space configuration and a time division duplexing (TDD) configuration the number of repetitions N and the number of plurality of downlink data transmissions M; and the terminal device comprises circuitry configured to determine the HARQ-ACK position for the m^{th} downlink data transmission by: determining a HARQ-ACK window for the m^{th} downlink data transmission based on the number of repetitions N and the number of plurality of downlink data transmissions M, the HARQ-ACK windowing comprising a plurality of discontinuous time slots; and in accordance with a determination that at least one time slot in the plurality of discontinuous time slots has valid downlink symbols for the m^{th} downlink data transmission, generating the HARQ-ACK position for the m^{th} downlink data transmission based on the further slot offset k₁′, the number of repetitions N, the number of plurality of downlink data transmissions M and the TDD configuration.

In some embodiments, the terminal device comprises circuitry configured to determine the HARQ-ACK codebook for the plurality of downlink data transmissions by determining the HARQ-ACK codebook based on a HARQ-ACK timing set, a time domain resource allocation (TDRA) table, and a subcarrier space configuration.

In some embodiments, the repetition pattern indicates that all repetitions for each downlink data transmission of the plurality downlink data transmissions are transmitted in continuous slots and the terminal device comprises circuitry configured to determine the HARQ-ACK codebook by: for a m^{th} downlink data transmission in the plurality of downlink data transmission, determining a further slot offset kin to be the (k1+Σᵢ₌ₘ₊₁^{M}Nᵢ), wherein Nᵢ represents the number of repetitions for the i^{th} downlink data transmission in the plurality of downlink data transmissions, M represents the number of the plurality of downlink data transmissions, k1 represents the slot offset, N, M, i and m are integer numbers, and m is smaller than M; and determining a HARQ-ACK position for the m^{th} downlink data transmission in the HARQ-ACK codebook based on the further slot offset k₁^{m}, the number of repetitions Nm for the m^{th} downlink data transmission, the number of plurality of downlink data transmission M and a time division duplexing (TDD) configuration.

In some embodiments, a type of the repetition pattern comprises: all repetitions for each downlink data transmission in the plurality downlink data transmissions are transmitted in continuous time slots; or one repetition for a group of the plurality of downlink data transmissions is transmitted in continuous time slots.

In some embodiments, the type of the repetition pattern is predetermined, or the type of the repetition pattern is configured by: a radio resource control configuration, or downlink control information.

In some embodiments, the terminal device comprises circuitry further configured to receive, from the network device, a radio resource control configuration indicating: the group of the plurality of downlink data transmissions comprises all of the plurality of downlink data transmissions; or the group of the plurality of downlink data transmissions comprises a subset of the plurality of downlink data transmissions.

In some embodiments, the number of repetitions for different downlink data transmission in the plurality of downlink data transmissions is the same or different and the terminal device comprises circuitry further configured to receive, from the network device, downlink control information indicating the number of repetitions for each downlink data transmission in the plurality downlink data transmissions; or receive, from the network device, a radio resource control configuration indicating the number of repetitions for each downlink data transmission in the plurality downlink data transmissions; or receive, from the network device, a further radio resource control configuration comprising a table of a plurality of repetition patterns, the table indicating the number of repetitions for each downlink data transmission for each repetition pattern; and receive, from the network device, further downlink control information comprising an indication of the repetition pattern for the plurality of downlink data transmissions.

In some embodiments, the feedbacks for the plurality of downlink data transmissions have a same priority and the priority is indicated in the downlink control information, or wherein the feedbacks for the plurality of downlink data transmissions have different priorities and the priorities of feedbacks for the plurality of downlink data transmissions are indicated in the downlink control information.

In some embodiments, a network device comprises circuitry configured to: transmit, at a network device and to a terminal device, downlink control information scheduling a plurality of downlink data transmissions with repetitions, the downlink control information indicating a slot offset between the last repetition of the last downlink data transmission in the plurality of downlink data transmissions and a transmission of an uplink control channel; and receive, from the terminal device and on the uplink control channel, a hybrid automatic repeat request acknowledgment (HARQ-ACK) codebook comprising feedbacks for the plurality of downlink data transmissions, which is determined based on the slot offset and a repetition pattern for the plurality of downlink data transmissions.

In some embodiments, a type of the repetition pattern comprises: all repetitions for each downlink data transmission in the plurality downlink data transmissions are transmitted in continuous time slots; or one repetition for a group of the plurality of downlink data transmissions is transmitted in continuous time slots.

In some embodiments, the type of the repetition pattern is predetermined, or the type of the repetition pattern is configured by: a radio resource control configuration, or downlink control information.

In some embodiments, the network device comprises circuitry further configured to transmit, to the terminal device, a radio resource control configuration indicating: the group of the plurality of downlink data transmissions comprises all of the plurality of downlink data transmissions; or the group of the plurality of downlink data transmissions comprises a subset of the plurality of downlink data transmissions.

In some embodiments, the number of repetitions for different downlink data transmission in the plurality of downlink data transmissions is the same or different, the network device comprises circuitry further configured to transmit, to the terminal device, downlink control information indicating the number of repetitions for each downlink data transmission in the plurality downlink data transmissions; or transmit, to the terminal device, a radio resource control configuration indicating the number of repetitions for each downlink data transmission in the plurality downlink data transmissions; or transmit, to the terminal device, a further radio resource control configuration comprising a table of a plurality of repetition patterns, the table indicating the number of repetitions for each downlink data transmission for each repetition pattern; and transmit, to the terminal device, further downlink control information comprising an indication of the repetition pattern for the plurality of downlink data transmissions.

In some embodiments, the plurality of downlink data transmissions have a same priority and the priority is indicated in the downlink control information, or wherein the plurality of downlink data transmissions have different priorities and the different priorities are indicated in the downlink control information.

In some embodiments, the acknowledgments for the plurality of downlink data transmissions have a same priority and the priority is indicated in the downlink control information, or wherein the acknowledgments for the plurality of downlink data transmissions have different priorities and the different priorities are indicated in the downlink control information.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to any of FIGS. 4-10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A communication method, comprising:
receiving, at a terminal device and from a network device, downlink control information scheduling a plurality of downlink data transmissions with repetitions, the downlink control information indicating a slot offset between the last repetition of the last downlink data transmission in the plurality of downlink data transmissions and a transmission of an uplink control channel;
determining, based on the slot offset and a repetition pattern for the plurality of downlink data transmissions, a hybrid automatic repeat request acknowledgment (HARQ-ACK) codebook for the plurality of downlink data transmissions; and
transmitting, to the network device and on the uplink control channel, the HARQ-ACK codebook comprising feedbacks for the plurality of downlink data transmissions.

2. The method of claim 1, wherein the repetition pattern indicates that all repetitions for each downlink data transmission of the plurality downlink data transmissions are transmitted in continuous time slots, and wherein determining the HARQ-ACK codebook comprises:
for a m^{th} downlink data transmission in the plurality of downlink data transmissions,
determining a further slot offset k₁′ to be the (k₁+N*(M−m)), wherein the further slot offset is a slot offset between the last repetition of the m^{th} downlink data transmission and the transmission of an uplink control channel, N represents the number of repetitions for the plurality of downlink data transmissions, M represents the number of the plurality of downlink data transmissions, k₁ represents the slot offset, m is smaller than M, and N, M and m are integer numbers; and
determining a HARQ-ACK position for the m^{th} downlink data transmission in the HARQ-ACK codebook based on the further slot offset k₁′.

3. The method of claim 1, wherein the repetition pattern indicates that one repetition for a group of the plurality of downlink data transmissions is transmitted in continuous time slots, and wherein determining the HARQ-ACK codebook comprises:
for a m^{th} downlink data transmission in the plurality of downlink data transmissions,
determining a further slot offset k₁′ to be the (k₁+M−m), wherein the further slot offset is a slot offset between the last repetition of the m^{th} downlink data transmission and the transmission of an uplink control channel, N represents the number of repetitions for the plurality of downlink data transmissions, M represents the number of the plurality of downlink data transmissions, k₁ represents the slot offset, m is smaller than M, and N, M and m are integer numbers; and
determining a HARQ-ACK position for the m^{th} downlink data transmission in the HARQ-ACK codebook based on the further slot offset k₁′.

4. The method of claim 3, wherein determining the HARQ-ACK codebook for the plurality of downlink data transmissions comprises:
determining the HARQ-ACK codebook based on a HARQ-ACK timing set, a time domain resource allocation (TDRA) table, a subcarrier space configuration and a time division duplexing (TDD) configuration, the number of repetitions N and the number of plurality of downlink data transmissions M; and
wherein determining the HARQ-ACK position for the m^{th} downlink data transmission comprises:
determining a HARQ-ACK window for the m^{th} downlink data transmission based on the further slot offset k₁′, the number of repetitions N and the number of plurality of downlink data transmissions M, the HARQ-ACK windowing comprising a plurality of discontinuous time slots; and
in accordance with a determination that at least one time slot in the plurality of discontinuous time slots has valid downlink symbols for the m^{th} downlink data transmission, generating the HARQ-ACK position for the m^{th} downlink data transmission.

5. The method of claim 3, wherein determining the HARQ-ACK codebook for the plurality of downlink data transmissions comprises:
determining the HARQ-ACK codebook based on a HARQ-ACK timing set, a time domain resource allocation (TDRA) table, and a subcarrier space configuration.

6. The method of claim 1, wherein the repetition pattern indicates that all repetitions for each downlink data transmission of the plurality downlink data transmissions are transmitted in continuous slots, and wherein determining the HARQ-ACK codebook comprises:
for a m^{th} downlink data transmission in the plurality of downlink data transmission,
determining a further slot offset k₁^{m} to be the (k₁+Σ₁₌ₘ₊₁^{M}Nᵢ), wherein Nᵢ represents the number of repetitions for the i^{th} downlink data transmission in the plurality of downlink data transmissions, M represents the number of the plurality of downlink data transmissions, k₁ represents the slot offset, N, M, i and m are integer numbers, and m is smaller than M; and
determining a HARQ-ACK position for the m^{th} downlink data transmission in the HARQ-ACK codebook based on the further slot offset k₁^{m}, the number of repetitions Nm for the m^{th} downlink data transmission, the number of plurality of the downlink data transmissions M and a time division duplexing (TDD) configuration.

7. The method of claim 1, wherein a type of the repetition pattern comprises:
all repetitions for each downlink data transmission in the plurality downlink data transmissions are transmitted in continuous time slots; or
one repetition for a group of the plurality of downlink data transmissions is transmitted in continuous time slots.

8. The method of claim 7, wherein the type of the repetition pattern is predetermined, or the type of the repetition pattern is configured by:
a radio resource control configuration, or
downlink control information.

9. The method of claim 7, further comprising:
receiving, from the network device, a radio resource control configuration indicating:
the group of the plurality of downlink data transmissions comprises all of the plurality of downlink data transmissions; or
the group of the plurality of downlink data transmissions comprises a subset of the plurality of downlink data transmissions.

10. method of claim 1, wherein the number of repetitions for different downlink data transmission in the plurality of downlink data transmissions is the same or different, and the method further comprises:
receiving, from the network device, downlink control information indicating the number of repetitions for each downlink data transmission in the plurality downlink data transmissions; or
receiving, from the network device, a radio resource control configuration indicating the number of repetitions for each downlink data transmission in the plurality downlink data transmissions; or
receiving, from the network device, a further radio resource control configuration comprising a table of a plurality of repetition patterns, the table indicating the number of repetitions for each downlink data transmission for each repetition pattern; and
receiving, from the network device, further downlink control information comprising an indication of the repetition pattern.

11. The method of claim 1, wherein the feedbacks for the plurality of downlink data transmissions have a same priority and the priority is indicated in the downlink control information, or wherein the feedbacks for the plurality of downlink data transmissions have different priorities and the priorities of feedbacks for the plurality of downlink data transmissions are indicated in the downlink control information.

12. A communication method, comprising:
transmitting, at a network device and to a terminal device, downlink control information scheduling a plurality of downlink data transmissions with repetitions, the downlink control information indicating a slot offset between the last repetition of the last downlink data transmission in the plurality of downlink data transmissions and a transmission of an uplink control channel; and
receiving, from the terminal device and on the uplink control channel, a hybrid automatic repeat request acknowledgment (HARQ-ACK) codebook comprising feedbacks for the plurality of downlink data transmissions, which is determined based on the slot offset and a repetition pattern for the plurality of downlink data transmissions.

13. The method of claim 12, wherein a type of the repetition pattern comprises:
all repetitions for each downlink data transmission in the plurality downlink data transmissions are transmitted in continuous time slots; or
one repetition for a group of the plurality of downlink data transmissions is transmitted in continuous time slots.

14. The method of claim 13, wherein the type of the repetition pattern is predetermined, or the type of the repetition pattern is configured by:
a radio resource control configuration, or
downlink control information.

15. The method of claim 13, further comprising:
transmitting, to the terminal device, a radio resource control configuration indicating:
the group of the plurality of downlink data transmissions comprises all of the plurality of downlink data transmissions; or
the group of the plurality of downlink data transmissions comprises a subset of the plurality of downlink data transmissions.

16. The method of claim 12, wherein the number of repetitions for different downlink data transmission in the plurality of downlink data transmissions is the same or different, and the method further comprises:
transmitting, to the terminal device, downlink control information indicating the number of repetitions for each downlink data transmission in the plurality downlink data transmissions; or
transmitting, to the terminal device, a radio resource control configuration indicating the number of repetitions for each downlink data transmission in the plurality downlink data transmissions; or
transmitting, to the terminal device, a further radio resource control configuration comprising a table of a plurality of repetition patterns, the table indicating the number of repetitions for each downlink data transmission for each repetition pattern; and
transmitting, to the terminal device, further downlink control information comprising an indication of the repetition pattern.

17. The method of claim 12, wherein the feedbacks for the plurality of downlink data transmissions have a same priority and the priority is indicated in the downlink control information, or wherein the feedbacks for the plurality of downlink data transmissions have different priorities and the priorities of feedbacks for the plurality of downlink data transmissions are indicated in the downlink control information.

18. A terminal device comprising:
a processor; and
a memory coupled to the processor and storing instructions thereon, the instructions, when executed by the processor, causing the terminal device to;
receive, from a network device, downlink control information scheduling a plurality of downlink data transmissions with repetitions, the downlink control information indicating a slot offset between the last repetition of the last downlink data transmission in the plurality of downlink data transmissions and a transmission of an uplink control channel;
determine, based on the slot offset and a repetition pattern for the plurality of downlink data transmissions, a hybrid automatic repeat request acknowledgment (HARQ-ACK) codebook for the plurality of downlink data transmissions; and
transmit, to the network device and on the uplink control channel, the HARQ-ACK codebook comprising feedbacks for the plurality of downlink data transmissions.

19.-21. (canceled)

22. The terminal device of claim 18, wherein the repetition pattern indicates that all repetitions for each downlink data transmission of the plurality downlink data transmissions are transmitted in continuous time slots, and wherein determining the HARQ-ACK codebook comprises:
for a m^{th} downlink data transmission in the plurality of downlink data transmissions,
determining a further slot offset k₁′ to be the (k₁+N*(M−m)), wherein the further slot offset is a slot offset between the last repetition of the m^{th} downlink data transmission and the transmission of an uplink control channel, N represents the number of repetitions for the plurality of downlink data transmissions, M represents the number of the plurality of downlink data transmissions, k₁ represents the slot offset, m is smaller than M, and N, M and m are integer numbers; and
determining a HARQ-ACK position for the m^{th} downlink data transmission in the HARQ-ACK codebook based on the further slot offset k₁′.

23. The terminal device of claim 18, wherein the repetition pattern indicates that one repetition for a group of the plurality of downlink data transmissions is transmitted in continuous time slots, and wherein determining the HARQ-ACK codebook comprises:
for a m^{th} downlink data transmission in the plurality of downlink data transmissions,
determining a further slot offset k₁′ to be the (k₁+M−m), wherein the further slot offset is a slot offset between the last repetition of the m^{th} downlink data transmission and the transmission of an uplink control channel, N represents the number of repetitions for the plurality of downlink data transmissions, M represents the number of the plurality of downlink data transmissions, k₁ represents the slot offset, m is smaller than M, and N, M and m are integer numbers; and
determining a HARQ-ACK position for the m^{th} downlink data transmission in the HARQ-ACK codebook based on the further slot offset k₁′.
